(19) United States
(12) Patent Application Publication
(10) Pub. No.: US 2013/0145631 A1
(43) Pub. Date: Jun. 13, 2013

(54) PALM ELECTRIC TOOL

(71) Applicant: CHERVON (HK) LIMITED, Wanchai (HK)

(72) Inventors: Guigong Ni, Nanjing (CN); Ping Wang, Nanjing (CN)

(73) Assignee: CHERVON (HK) LIMITED, Wanchai (HK)

(21) Appl. No.: 13/653,805

(22) Filed: Oct. 17, 2012

(30) Foreign Application Priority Data
Dec. 7, 2011 (CN) 201120504495.3

(51) Int. Cl. B23D 49/16; B25F 5/02

(52) U.S. Cl. 30/374; 173/31

(57) ABSTRACT

A palm electric tool includes a housing adapted for palm gripping, a base connected to the housing for contacting with a workpiece and supporting the palm electric tool, a motor with an output shaft arranged within the housing. The output shaft is substantially parallel to the base. A transmission mechanism is connected to the output shaft of the motor which includes a slide bar. The slide bar is capable of being moved in a direction perpendicular to the output of the motor, a blade is connected to the slide bar which is positioned substantially perpendicular to the output of the motor and the base. A battery pack for powering the motor is inserted into the housing. An inserting direction of the battery pack is substantially parallel to the output shaft of the motor. The battery pack is positioned between the motor and the base and partially overlapped with the motor in a direction perpendicular to the base.

### RELATED APPLICATION DATA

This application claims the benefit of CN 201120504495.3, filed on Dec. 7, 2011, the disclosure of which is incorporated herein by reference in its entirety.

### BACKGROUND

This disclosure generally relates to electric tools and, more particularly, to a palm electric tool.

At present, palm electric tools refer to small electric tools using electrical power as the basis of power and enabling a user to operate the tool by holding the tool in their hand to perform certain functions, for example palm jig saws. Since electric tools of this kind are used flexibly, they generally carry a battery pack as a source of electrical power. For continuous supply of electrical power, the battery pack generally needs to store sufficient electrical energy, and correspondingly a weight of the battery pack accounts for a large proportion of the weight of the whole machine, so the location of the battery pack becomes a key point of affecting the working stability of the palm electric tool, and positional relationship between the battery pack, a motor, and a transmission mechanism cooperatively decide convenience and comfort in operation of the electric tool. Currently, the body structure of palm electric tools, particularly the design of the location of the battery pack, often causes problems such as an excessively large size of the whole machine and a higher center of gravity of the whole machine. Taking the current jig saw as an example, the battery pack is generally disposed to the rear of the motor and inserted in a direction substantially parallel to a movement direction of a slide bar driving the jig saw. Thus, the size of the whole machine is relatively large and the center of gravity is relatively high, which decreases convenience of operation.

### SUMMARY

In order to overcome the drawbacks of the prior art, the following describes a palm electric tool which has a smaller whole machine size and a lower center of gravity.

The palm electric tool includes a housing adapted for palm gripping, a base connected to the housing for contacting with a workpiece and supporting the palm electric tool, a motor with an output shaft arranged within the housing. The output shaft is substantially parallel to the base. A transmission mechanism is connected to the output shaft of the motor which includes a slide bar. The slide bar is capable of being moved in a direction perpendicular to the output of the motor, a blade is connected to the slide bar which is positioned substantially perpendicular to the output of the motor and the base. A battery pack for powering the motor is inserted into the housing. An inserting direction of the battery pack is substantially parallel to the output shaft of the motor. The battery pack is positioned between the motor and the base and partially overlapped with the motor in a direction perpendicular to the base.

Since the battery pack is positioned between the motor and the base, the center of gravity of the battery pack is more adjacent to the base, thus a center of gravity of the electric tool is lowered. Therefore, the vibrate of the electric tool is reduced due to a lower center of gravity, and the electric tool is easy to control which provides an enhanced user comfort.

### BRIEF DESCRIPTION OF THE DRAWINGS

FIG. 1 is a schematic view showing internal structure of a palm electric tool, wherein an arrow A is provided to indicate an inserting direction of a battery pack; and

FIG. 2 is a perspective structural schematic view of the external of the embodiment shown in FIG. 1.

### DETAILED DESCRIPTION

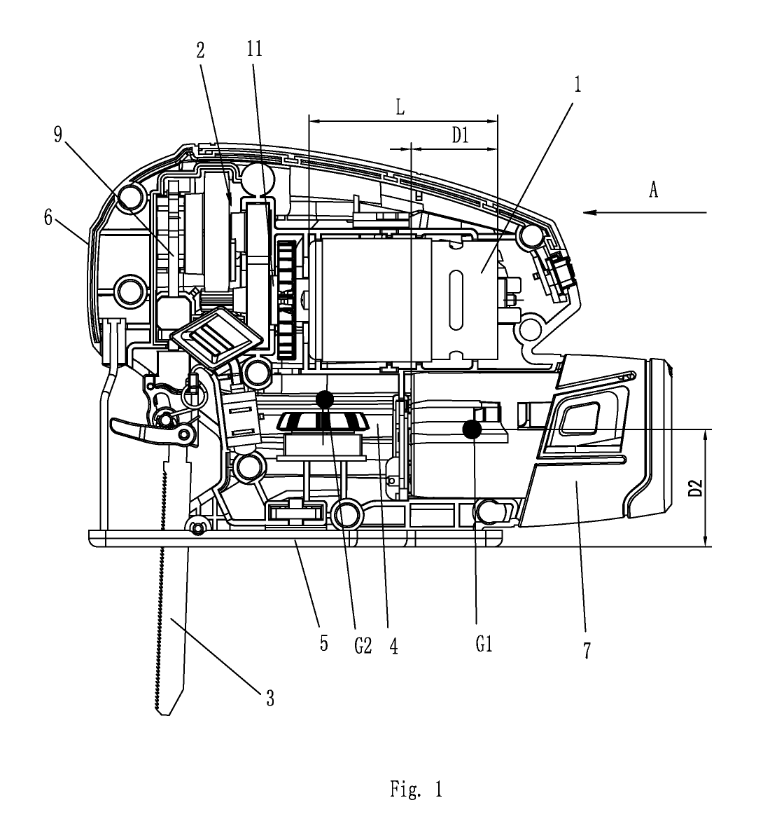

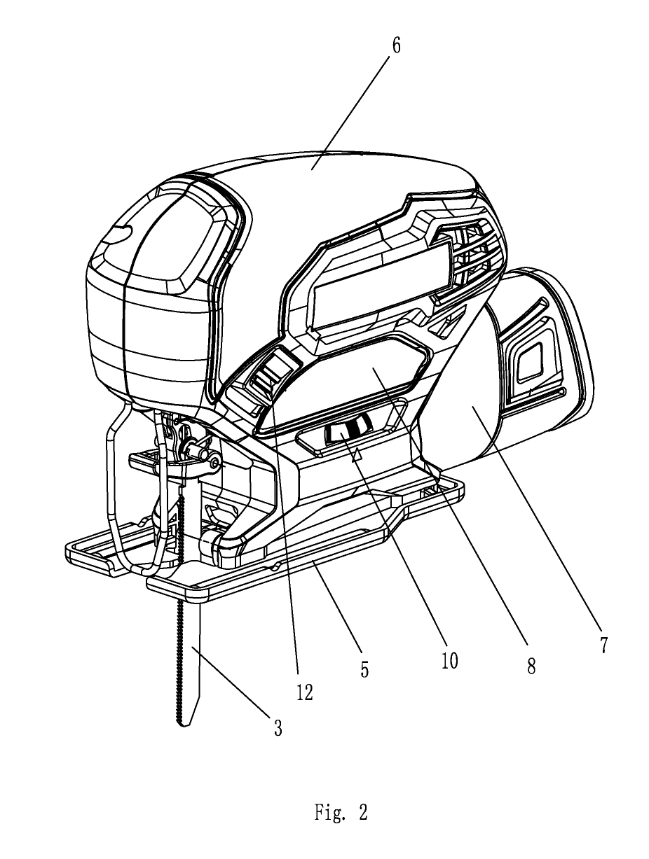

Referring to FIG. 1 and FIG. 2, a body structure adapted for a palm electric tool includes a motor 1, a transmission mechanism 2, an implement 3, an electric component 4, a base 5, a housing 6 and a battery pack 7.

The motor 1 converts the electrical energy of the battery pack 7 into the mechanical power, the transmission mechanism 2 transmits the mechanical power output by an output shaft 11 of the motor 1 to the implement 3 to enable the implement 3 to make a regular movement to achieve the function of the electric tool. The implement 3 is a member performing a specific function such as bore drilling or sawing. The electric component 4 is capable of providing electrical power of the battery pack 7 to the motor 1 and controlling operation of the whole electric tool. The base 5 is connected to the housing 6 so as to support the whole body and provide a plane in contact with a workpiece to be processed. The housing 6 is used to fix and protect the internal structures and includes a gripping structure (not labeled) formed on an outer portion for ease of gripping. The battery pack 7 is used to provide electrical power.

As shown in FIG. 1 and FIG. 2, the implement 3 may be a jig saw blade, i.e., the body structure adapted for a palm electric tool according to the present invention is described in the form of a palm jig saw as a specific example. When the implement 3 is the jig saw blade, the transmission mechanism 2 includes a slide bar 9 for driving the jig saw blade and the slide bar 9 moves in a direction perpendicular to the output shaft 11 of the motor 1, i.e., perpendicular to an insertion direction of the battery pack 7 as shown by the arrow A. Two sides of the jig saw blade are parallel to the output shaft 11 of the motor 1, i.e., the jig saw blade is intended to travel in a direction perpendicular to the insertion direction A of the battery pack 7 during operation.

As shown in FIG. 1, the output shaft 11 of the motor 1 is connected to the transmission mechanism 2, the transmission mechanism 2 is connected to the implement 3 and drives it to work and the motor 1 is electrically connected to the electric component 4. The base 5 is positioned on the bottom of the housing 6, and the battery pack 7 is inserted into the housing 6 in a direction parallel to the output shaft 11 of the motor 1, that is, the direction indicated by the arrow A in FIG. 1.

The motor 1 and the electric component 4 are both disposed in the housing 6, and the transmission mechanism 2 and the battery pack 7 are partially positioned in the housing 6. When the electric tool is in a state shown in FIG. 1, the vertical direction defines a height direction of the electric tool and the horizontal direction defines a lengthwise direction of the electric tool. When viewed in the lengthwise direction, the battery pack 7 is partially located outside the housing 6, partially located inside the housing 6, and partially overlaps the motor 1 in the height direction. The motor 1 has a length L. An overlap area D1 of the motor 1 and the battery pack 7 is at least 1/10 of the length L of the motor 1. Preferably, the overlap area D1 is ½ of the length of the motor 1. Such an arrangement reduces the dimension of the electric tool in the lengthwise direction. When viewed in the height direction, the battery pack 7 is located between the motor 1 and the base 5. The battery pack 7 has a center of gravity G1. A distance D2 between the center of gravity G1 of the battery pack 7 and the base 5 is in a range from 20 mm to 50 mm. Preferably, the distance D2 is 35 mm. The center of gravity G1 is so adjacent to the base 5 such that a center of gravity G2 of the palm electric tool is lowered. Thus the dimension of the electric tool in height direction is reduced, and the palm electric tool is easy to control.

Preferably, a profile of the battery pack 7 is designed in a way that the lengthwise direction of the battery pack 7, that is, the direction of the battery pack 7 having the longest horizontal dimension, should be parallel to the output shaft 11 of the motor 1. That is to say, the lengthwise extension direction of the battery pack 7 is substantially parallel to the direction of the output shaft 11 of the motor 1.

Preferably, as shown in FIG. 2, the housing 6 includes a first side wall and a second side wall (not labeled) opposite to the first side wall (not labeled). The first and second side walls respectively define a first recess 8 and a second recess (not shown) for gripping by a user. The second recess is opposite to the first recess 8 and has substantially the same shape as the first recess 8. The first recess 8 is adapted for placing the thumb of the user and the second recess is adapted for placing the other four fingers of the user. A top portion of the housing 6 arches to adapt for the user's palm shape so that the user's four fingers grip the second recess on the second side wall and the thumb grips the first recess 8 on the first side wall so as to hold the electric tool. A lengthwise direction of the outline of the first recess 8, namely, the direction of the first recess 8 having the longest horizontal dimension is parallel to the output shaft 11 of the motor 1. When the whole body is held, the user's forearm is substantially perpendicular to the output shaft 11 of the motor 1. Such design of the housing 6 highlights that the battery pack 7 functions to lower the center of gravity. Besides, the battery pack 7 does not hinder the user's gripping, nor causes inconvenience due to its dimensions when the user moves the device, and therefore allows for very comfortable operation. For ease of operation, an adjust knob 10 for controlling the speed of the motor 1 is positioned below the first recess 8, a switch 12 for on/off the motor 1 is positioned adjacent to the first recess 8, so the user's thumb can easily contact the adjust knob 10 and the switch 12 for timely controlling the motor 1.

The above description, provided by way of example only, is not intended to limit the present invention to any particular form. Rather, the invention as claimed is to be provided with a scope so as to encompass equivalent substitutions or equivalent variations of the exemplary elements described.

What is claimed is:

1. A palm electric tool, comprising:
a housing adapted for palm gripping;
a base connected to the housing for contacting with a workpiece and supporting the palm electric tool;
a motor having an output shaft arranged within the housing, the output shaft being substantially parallel to the base;
a transmission mechanism connected to the output shaft of the motor which comprises a slide bar, the slide bar being capable of moving in a direction substantially perpendicular to the output of the motor;
a blade connected to the slide bar which is positioned substantially perpendicular to the output of the motor and the base;
a battery pack for powering the motor being capable of inserting into the housing, an inserting direction of the battery pack being substantially parallel to the output shaft of the motor, the battery pack being positioned between the motor and the base and partially overlapped with the motor in a direction perpendicular to the base.

2. The palm electric tool according to claim 1, wherein an overlap area of the motor and the battery pack is at least 1/10 of the length of motor.

3. The palm electric tool according to claim 2, wherein the overlap area of the motor and the battery pack is ½ of the length of the motor.

4. The palm electric tool according to claim 1, wherein a distance between the center of gravity of the battery pack and the base is in a range from 20 mm to 50 mm.

5. The palm electric tool according to claim 1, wherein the housing comprises a first side wall and a second side wall opposite to the first side wall, the first side wall defines a first recess adapted for placing the thumb of a user and the second side wall defines a second recess adapted for placing the other four fingers of the user.

6. The palm electric tool according to claim 5, further comprises an adjust knob positioned below the first recess which is operable by the thumb of the user to control the speed of the motor.

7. The palm electric tool according to claim 5, further comprises a switch adjacent to the first recess which is operable by the thumb of the user to switch on/off the motor.

8. A palm electric tool, comprising:
a housing adapted for palm gripping;
a base connected to the housing for contacting with a workpiece and supporting the palm electric tool;
a motor with an output shaft arranged within the housing, the output shaft being substantially parallel to the base;
a transmission mechanism connected to the output shaft of the motor;
an implement connected to the transmission mechanism; and
a battery pack for powering the motor inserted into the housing, an inserting direction of the battery pack being substantially parallel to the output shaft of the motor, the battery pack being positioned between the motor and the base and partially overlapped with the motor in a direction perpendicular to the base.

9. The palm electric tool according to claim 8, wherein an overlap area of the motor and the battery pack is at least 1/10 of the length of motor.

10. The palm electric tool according to claim 9, wherein the overlap area of the motor and the battery pack is ½ of the length of the motor.

11. The palm electric tool according to claim 8, wherein the battery pack has a center of gravity, a distance between the center of gravity of the battery pack and the base is in a range from 20 mm to 50 mm.

12. The palm electric tool according to claim 8, wherein the battery pack has a lengthwise direction substantially parallel to the output shaft of the motor.

13. The palm electric tool according to claim 8, wherein the housing comprises a first side wall and a second side wall opposite to the first side wall, the first side wall defines a first recess adapted for placing the thumb of a user and the second side wall defines a second recess adapted for placing the other four fingers of the user.

14. The palm electric tool according to claim 13, further comprises an adjust knob positioned below the first recess which is operable by the thumb of the user to control the speed of the motor.

15. The palm electric tool according to claim 13, further comprises a switch positioned adjacent to the first recess which is operable by the thumb of the user to switch on/off the motor

16. The palm electric tool according to claim 8, wherein the implement is a jig saw blade, and the transmission mechanism comprises a slide bar which drives the jig saw blade to move in a direction perpendicular to the output shaft of the motor.

17. The palm electric tool according to claim 16, wherein the implement has two opposite sides which are substantially parallel to the output shaft of the motor.
